(19) United States
(12) Patent Application Publication
(10) Pub. No.: US 2013/0098070 A1
(43) Pub. Date: Apr. 25, 2013

(54) PRESSURE CONTROL APPARATUS FOR CRYOGENIC STORAGE TANKS

(71) Applicants: Stephen A. McCORMICK, Warrington, PA (US); Michael D. NEWMAN, Hillsborough, NJ (US)

(72) Inventors: Stephen A. McCORMICK, Warrington, PA (US); Michael D. NEWMAN, Hillsborough, NJ (US)

(21) Appl. No.: 13/280,723

(22) Filed: Oct. 25, 2011

(51) Int. Cl. F28D 15/02; F17C 3/00

(52) U.S. Cl. 62/45.1

(57) ABSTRACT

A pressure control apparatus for a cryogenic storage tank includes a heat pipe extending into the storage tank and having a first end in contact with liquid cryogen in the storage tank, and a second end exposed to an atmosphere external to the storage tank such that heat flux occurs in the liquid cryogen proximate the first end of the heat pipe for providing a cryogenic gas and pressure to the liquid cryogen in the storage tank. Another embodiment includes a sleeve for the second end to control the heat flux in the liquid cryogen.

### BACKGROUND OF THE INVENTION

The present inventive embodiments relate to apparatus used to control pressure of bulk storage tanks.

Cryogenic bulk liquid storage tanks typically use an external vaporizer to control pressure of said tanks. Such vaporizers are structurally large, require additional space adjacent to the bulk storage tank, and are expensive to manufacture, store and maintain. Regulating the pressure within such tanks is necessary for providing a constant liquid pressure to processing equipment which uses the cryogen liquid. It is necessary to maintain the cryogenic tanks at a constant pressure to overcome piping losses to the pressure enroute to the processing equipment. As cryogenic liquid is drawn from the bulk storage tank in large volumes, the tank pressure will be reduced, which causes flow rates of the liquid to the processing equipment to be reduced. Therefore, pressure maintenance of the storage tank is critical.

It would therefore be desirable not to rely upon a vaporizer which consumes valuable space and resource to maintain, but still be able to control the pressure in the storage tank.

Therefore, there is provided herein by the inventive embodiments a cryogenic storage tank with pressure control so that a vaporizer is not required.

### BRIEF DESCRIPTION OF THE DRAWINGS

For a more complete understanding of the present embodiments, reference may be had to the following drawing figures taken in conjunction with the description of the embodiments, of which:

FIGS. 1 and 2 disclose a cryogenic bulk storage tank with pressure control embodiment of the invention.

FIG. 3 discloses another embodiment of a pressure control embodiment.

### DETAILED DESCRIPTION OF THE INVENTION

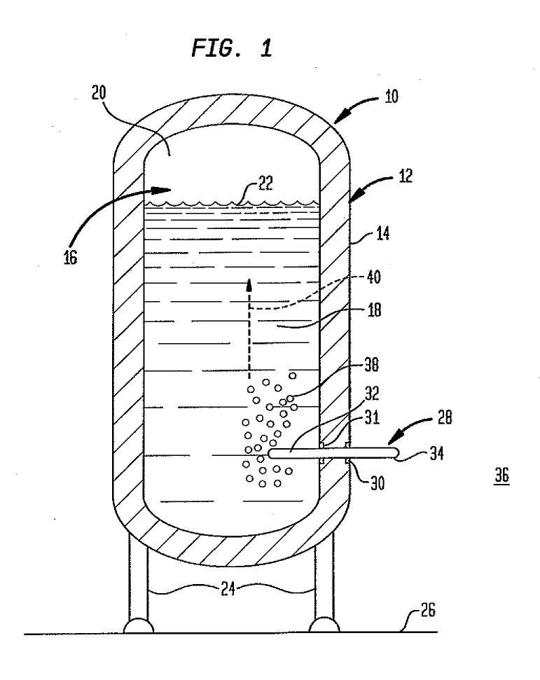

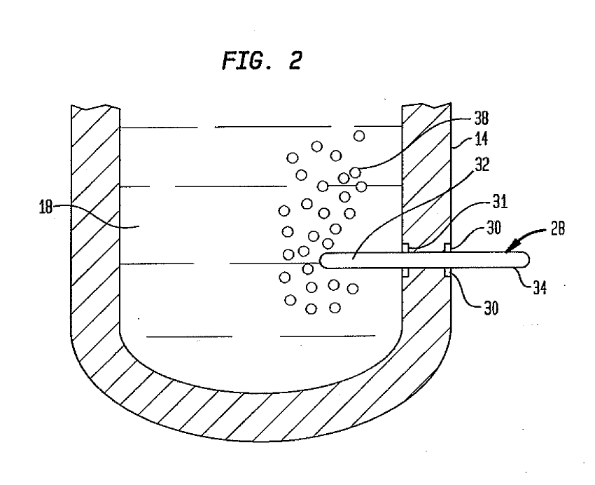

Referring to FIGS. 1 and 2, a cryogenic storage vessel with heat pipe embodiment is shown generally at 10 and includes a storage tank 12 or vessel having a sidewall 14 which may be vacuum jacketed or insulated. The tank 12 may be used for containing liquid, such as for example a cryogenic liquid. The sidewall 14 provides an interior chamber 16 or space within the tank 12. The chamber 16 is constructed to receive the cryogenic liquid 18, which may be for example liquid nitrogen (N₂), liquid carbon dioxide (CO₂), or liquid oxygen (O₂) A head space 20 exists above an upper surface 22 of the cryogenic liquid 18. The tank 12 has a plurality of legs 24 or support members extending therefrom to support the tank off an underlying surface 26.

At least one heat pipe 28 extends through the sidewall 14 at a lower portion of the tank 12. Seals 30 or gaskets at an exterior of the tank, and seals 31 or gaskets at an interior of the tank prevent the cryogenic liquid 18 from leaking or seeping through the sidewall 14 along the heat pipe 28 from the tank 12. The heat pipe 28 is used to control the pressure in the tank 12 by adjusting pressure in the head space 20.

The heat pipe 28 may be a variable conductance type heat pipe, and is arranged generally so that its longitudinal axis is substantially parallel to the underlying surface 26.

One end 32 (the cryogenic end) of the heat pipe 28 extends into and is immersed in the cryogenic liquid 18, while an opposed end 34 (the atmospheric end) of the heat pipe extends to be exposed to an atmosphere 36 external to the tank 12. Heat from the atmosphere 36 is transferred from such external environment into the cryogenic liquid 18 through the heat pipe 28. Accordingly, the cryogenic liquid 18 in close proximity to the cryogenic end 32 of the heat pipe 28 experiences a phase change and is converted to a cryogenic gas 38. The cryogenic gas 38 rises to an upper level of the interior chamber 16 as indicated by arrow 40, thereby increasing a pressure in the head space 20 of the tank 12. The conductance of the heat pipe 28 can be varied so that the pressure in the head space 20 can be regulated by an amount of heat transferred through the heat pipe 28 into the cryogenic liquid 18 contained in the tank 12.

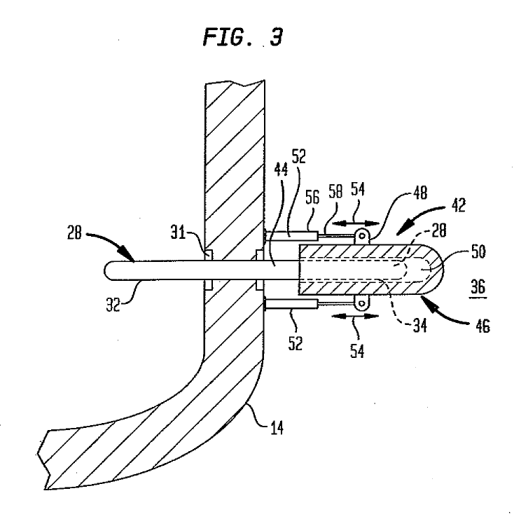

Referring to FIG. 3, an alternative embodiment of the pressure control apparatus is shown generally at 42 and calls for controlling exposure of a select amount of an exterior surface 44 of the atmospheric end 34 of the heat pipe 28 to the atmosphere 36. Such construction controls and where necessary reduces if not eliminates any heat leak into the cryogenic liquid 18 for heat pipes which have limited variable conductance capabilities.

The embodiment 42 includes a shield 46 or sleeve, which may be insulated, and at least one mounting member 48, projection or ear extending therefrom at approximately a mid-section of the sleeve. A pair of the mounting members 48 may be used to provide for applying a more uniform and consistent force to the sleeve 46. An interior of the sleeve is provided with a space 50 sized and shaped to receive an entire portion of the atmospheric end 34 of the heat pipe 28. At least one actuator 52, mechanical, electrical or hydraulic, is mounted to the tank side wall 14. Alternatively, a pair of the actuators 52 may be used which are spaced apart to permit the sleeve 46 to reciprocate therebetween in the direction of arrows 54. The actuator 52 may be a piston or similar device. Each of the actuators 52 can be for example a cylinder 56 with a piston 58 having a movable end connected to a respective one of the ears 48 extending from the sleeve 46. A control apparatus (not shown) may control operation of the actuators 52. The sleeve 46 can be constructed from any type of insulatory material and may have an exterior surface made from a material selected from plastic, metal, aluminum or an alloy to withstand contact with objects in close proximity to the tank 12.

In operation, the sleeve 46 is moved by the actuators 52 to be positioned to cover a select amount of the atmospheric end 34 of the heat pipe 28, depending upon the amount of heat transfer that is suppose to occur at the cryogenic end 32 of the heat pipe. In this manner of operation, the amount of the cryogenic gas 38 produced can be controlled which is to flow to the head space 20 of the tank. That is, if the amount of cryogenic liquid 18 in the tank 12 is full, there will be sufficient pressure at the head space 20 to force the cryogenic liquid from the tank 12. However, as the cryogenic liquid 18 in the tank 12 is drawn down and reduced, additional pressure will be necessary in order to maintain a continuous pressure of the cryogenic liquid being transferred to the processing apparatus (not shown). Therefore, the actuators 52 will be operated to move the sleeve 46 to expose a greater amount of the atmospheric end 34 of the heat pipe 28 to increase the amount of heat transfer in the cryogenic liquid 18, thereby providing a greater amount of the cryogen gas 38 to increase pressure in the head space 20. When the tank 12 is refilled with the cryogenic liquid 18, the actuators 52 can be operated to move the sleeve 46 to a position closer to the tank side wall 14 to cover more if not all of the atmospheric end 34 to reduce the amount of heat transfer, and therefore the cryogenic gas 38 for the head space 20.

The reciprocating movement of the sleeve 46 which is operated by the actuators 52 permits a select amount of the exterior surface 44 of the heat pipe 28 to be exposed to the external atmosphere 36. A plurality of the pressure control embodiments 42 may be used with a single tank 12, if such tank is of an extremely large size.

A plurality of the heat pipe 28 can be used with the storage tank 12. The sleeve 46 can be used with each one of the heat pipes 28 used, and the actuators 52 can be used with each of the sleeves 46.

Such embodiments of FIGS. 1-3 overcome the need for a vaporizer, and also reduce the overall cost of the cryogenic liquid storage tank or system.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A pressure control apparatus for a cryogenic storage tank, comprising:
a heat pipe extending into the storage tank and having a first end in contact with liquid cryogen in the storage tank, and a second end exposed to an atmosphere external to the storage tank such that heat flux occurs in the liquid cryogen proximate the first end of the heat pipe for providing a cryogenic gas and pressure to the liquid cryogen in the storage tank.

2. The pressure control apparatus of claim 1, further comprising at least one seal disposed in a wall of the storage tank through which the heat pipe extends for preventing the liquid cryogen from leaking from the storage tank.

3. The pressure control apparatus of claim 1, wherein the heat pipe comprises a longitudinal axis extending transverse to a longitudinal access of the storage tank when the heat pipe is extending into the storage tank.

4. The pressure control apparatus of claim 3, wherein the heat pipe is disposed perpendicular to the longitudinal access of the storage tank.

5. The pressure control apparatus of claim 1, wherein the heat pipe is variably conductive.

6. The pressure control apparatus of claim 1, further comprising:
a sleeve having an internal space therein sized and shaped to receive the second end of the heat pipe; and
a first actuator apparatus having a first portion mounted to the storage tank and a second portion connected to the first portion and mounted to the sleeve, the second portion constructed for reciprocating movement with respect to the first portion to move the internal space of the sleeve with respect to the second end of the heat pipe for exposing a select amount of the second end to the atmosphere.

7. The pressure control apparatus of claim 6, further comprising at least one projecting member extending from the sleeve for being connected to the second portion of the first actuator apparatus.

8. The pressure control apparatus of claim 6, wherein the sleeve is insulated.

9. The pressure control apparatus of claim 6, wherein an exterior surface of the sleeve comprises a shell of material selected from the group consisting of plastic, steel, aluminum and an alloy.

10. The pressure control apparatus of claim 6, further comprising a second actuator apparatus having a first portion mounted to the storage tank and a second portion connected to the first portion and mounted to the sleeve, the second actuator apparatus constructed for reciprocating movement and spaced apart from the first actuator apparatus for actuating the sleeve to reciprocate between the first and second actuators.

11. The pressure control apparatus of claim 1, further comprising:
a sleeve having an internal space therein sized and shaped to receive the second end of the heat pipe; and
at least one piston operatively associated with the sleeve for providing reciprocating movement to the sleeve to move the internal space to cover a select portion of the second end of the heat pipe.
